(19) United States
(12) Patent Application Publication
(10) Pub. No.: US 2025/0358892 A1
(43) Pub. Date: Nov. 20, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/289,675

(22) Filed: Aug. 4, 2025

Related U.S. Application Data
(63) Continuation of application No. PCT/JP2024/003197, filed on Feb. 1, 2024.
(60) Provisional application No. 63/443,085, filed on Feb. 3, 2023.

(51) Int. Cl. H04W 76/27; H04W 76/40

(52) U.S. Cl. CPC H04W 76/27; H04W 76/40

(57) ABSTRACT

A communication method used in a mobile communication system for providing a multicast/broadcast service (MBS) includes the steps of: suspending, by a user equipment in a radio resource control (RRC) connected state, a first multicast radio bearer (MRB) in response to transitioning from the RRC connected state to an RRC inactive state after establishing the first MRB with a network; receiving, by the user equipment in the RRC inactive state, a multicast session via a second MRB from the network; and performing, by the user equipment, predetermined processing of switching from reception of the multicast session via the second MRB to reception of the multicast session via the first MRB, when the user equipment performs RRC connection resume to transition from the RRC inactive state to the RRC connected state.

### RELATED APPLICATIONS

The present application is a continuation based on PCT Application No. PCT/JP2024/003197, filed on Feb. 1, 2024, which claims the benefit of U.S. Provisional Patent Application No. 63/443,085 filed on Feb. 3, 2023. The content of which is incorporated by reference herein in their entirety.

### TECHNICAL FIELD

The present disclosure relates to a communication method and a user equipment used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V17.3.0

### SUMMARY

A communication method according to a first aspect is a communication method used in a mobile communication system for providing a multicast/broadcast service (MBS), the communication method including the steps of: suspending, by a user equipment in a radio resource control (RRC) connected state, a first multicast radio bearer (MRB) in response to transitioning from the RRC connected state to an RRC inactive state after establishing the first MRB with a network; receiving, by the user equipment in the RRC inactive state, a multicast session via a second MRB from the network; and performing, by the user equipment, predetermined processing of switching from reception of the multicast session via the second MRB to reception of the multicast session via the first MRB, when the user equipment performs RRC connection resume to transition from the RRC inactive state to the RRC connected state.

A user equipment according to a second aspect is a user equipment used in a mobile communication system for providing a multicast/broadcast service (MBS), the user equipment including: a controller configured to suspend a first multicast radio bearer (MRB) in response to transitioning from a radio resource control (RRC) connected state to an RRC inactive state after establishing, in the RRC connected state, the first MRB with a network; and a receiver configured to receive, in the RRC inactive state, a multicast session via a second MRB from the network. The controller is configured to perform predetermined processing of switching from reception of the multicast session via the second MRB to reception of the multicast session via the first MRB, when the user equipment performs RRC connection resume to transition from the RRC inactive state to the RRC connected state.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIGS. 6A and 6B are diagrams illustrating an overview of an operation of enabling a UE 100 in an RRC inactive state to perform multicast reception.

FIG. 7 is a diagram illustrating a first operation scenario according to an embodiment.

FIG. 8 is a diagram illustrating a second operation scenario according to an embodiment.

FIG. 9 is a flowchart illustrating an overview of operations according to an embodiment.

FIG. 10 is a diagram for describing a PDCP count value.

FIG. 11 is a diagram illustrating an example of a first operation pattern according to an embodiment.

FIG. 12 is a diagram illustrating a configuration example of a PDCP status report.

FIG. 13 is a diagram illustrating an example of a second operation pattern according to an embodiment.

FIG. 14 is a diagram illustrating another example of the second operation pattern according to an embodiment.

FIG. 15 is a diagram illustrating an example of a third operation pattern according to an embodiment.

FIG. 16 is a diagram illustrating an example of a fourth operation pattern according to an embodiment.

FIG. 17 is a diagram illustrating an example of a fifth operation pattern according to an embodiment.

FIGS. 18A and 18B are diagrams illustrating a PTM configuration delivery procedure for an activated multicast session.

### DESCRIPTION OF EMBODIMENTS

A mobile communication system according to an embodiment is described with reference to the drawings. In the description of the drawings, the same or similar parts are denoted by the same or similar reference signs.

### (1) SYSTEM CONFIGURATION

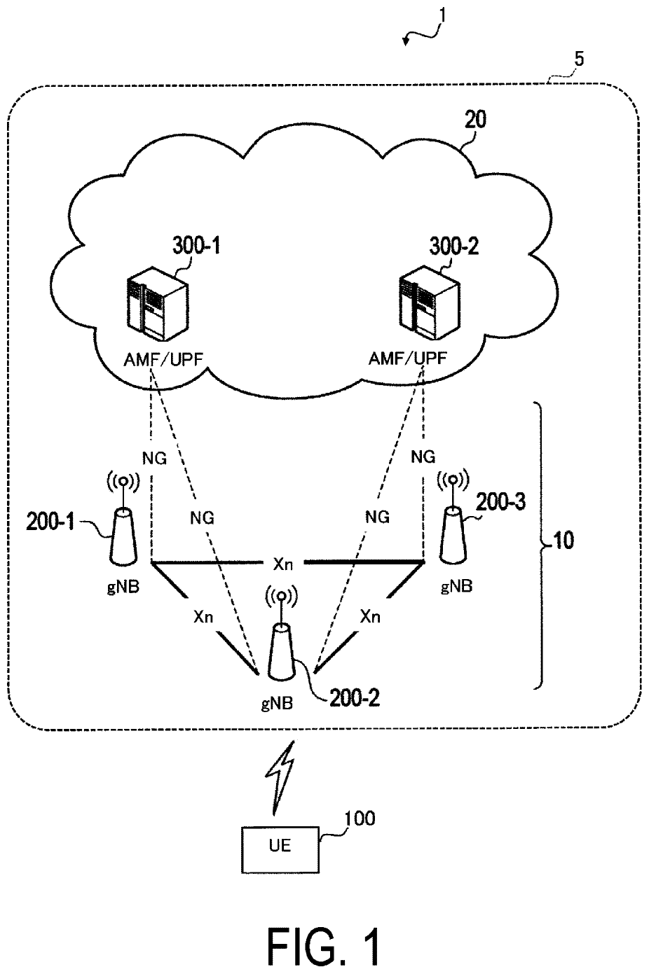

FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

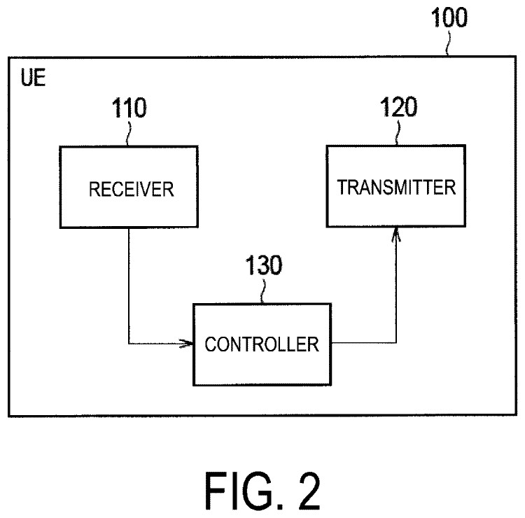

FIG. 2 is a diagram illustrating a configuration of the UE 100 (the user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may be also performed under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

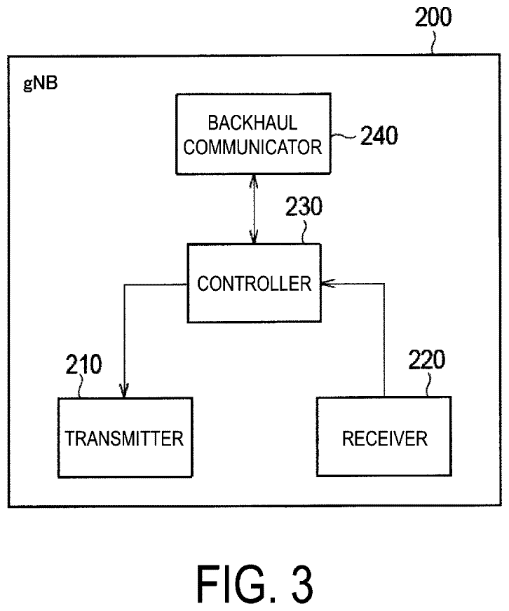

FIG. 3 is a diagram illustrating a configuration of the gNB 200 (the base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

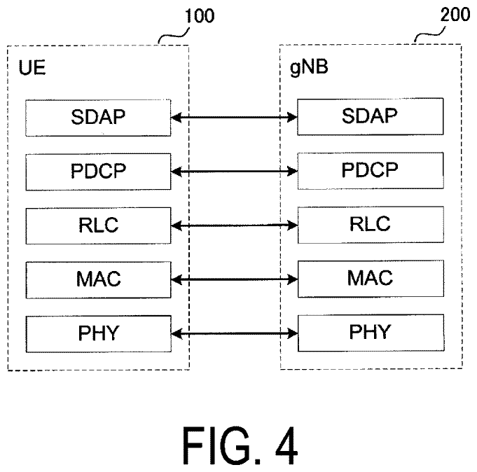

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

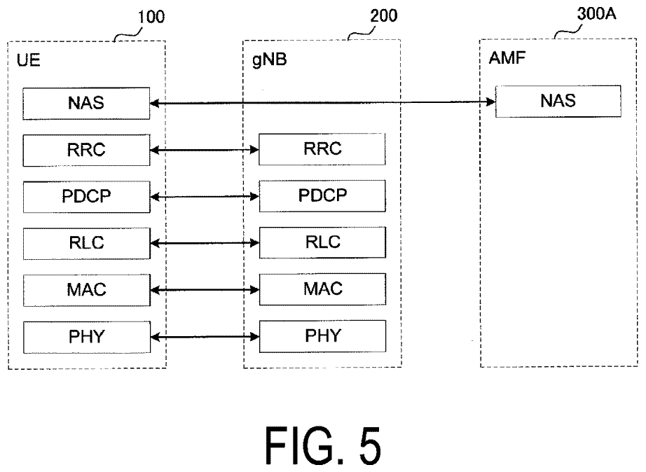

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also referred to simply as an “NAS”) that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. Each layer lower than the NAS layer will be referred to as an AS layer (also referred to simply as an “AS”).

### (2) MBS

The mobile communication system 1 can perform delivery with high resource efficiency by using the multicast/broadcast service (MBS). Note that a session refers to a sequence of communication (from start to end) of a service (an application), and an MBS session refers to a session used in the MBS.

In a case of a multicast communication service (also referred to as “MBS multicast”), the same service and the same specific content data are simultaneously provided to a specific UE set. That is, not every UE 100 in the multicast service area is permitted to receive data. The multicast communication services are delivered to the UE 100 using a multicast session that is a type of an MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or the RRC idle) state. Such a delivery mode will be also referred to as the “delivery mode 1”. Note that the UE 100 can receive a multicast session only after joining the multicast session. Here, joining the multicast session may mean that the UE 100 is registered in the network 5 (the CN 20) as being capable of receiving the multicast session.

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of an MBS session. The UE 100 can receive the broadcast communication services in any state of the RRC idle state, the RRC inactive state, and the RRC connected state. Such a delivery mode will be also referred to as “delivery mode 2”.

Main logical channels used for MBS delivery are a Multicast Traffic CHannel (MTCH), a Dedicated Traffic CHannel (DTCH), and a Multicast Control CHannel (MCCH). The MTCH is a PTM downlink channel for transmitting MBS data of a multicast session and/or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100. In the delivery mode 1, an MBS configuration for the UE 100 is performed using a dedicated control channel (DCCH).

For transmission of MBS data packets (also referred to as “MBS packets”), in the MBS multicast, any of point-to-point (PTP) transmission corresponding to unicast and point-to-multipoint (PTM) transmission can be applied. On the other hand, in the MBS broadcast, only the PTM transmission can be applied. For the PTP transmission, the gNB 200 can deliver a separate copy of an MBS packet to each UE 100 independently. For example, the gNB 200 uses a UE-specific PDCCH with a cyclic redundancy code (CRC) scrambled by a UE-specific RNTI (e.g., the C-RNTI) to schedule a UE-specific PDSCH scrambled by a UE-specific RNTI. On the other hand, for the PTM transmission, the gNB 200 delivers a single copy of an MBS packet to a set (group) of a plurality of UEs 100. For example, the gNB 200 uses a group-common PDCCH with a CRC scrambled by a group-common RNTI (e.g., the G-RNTI) to schedule a group-common PDSCH scrambled by a group-common RNTI.

Regarding a configuration for MBS broadcast, the UE 100 in the RRC idle state, the RRC inactive state, or the RRC connected state receives a PTM configuration for a broadcast session (e.g., parameters necessary for MTCH reception) via the MCCH. Parameters necessary for reception of the MCCH (MCCH configuration) are provided through system information. More specifically, system information block/type 20 (the SIB 20) includes the MCCH configuration. Note an SIB type 21 (the SIB 21) includes information relating to service continuity of MBS broadcast reception. The MCCH provides a list of all broadcast services including ongoing sessions transmitted on the MTCH, and the related information of the broadcast session includes an MBS session identifier (e.g., Temporary Mobile Group Identity (TMGI)), related MTCH scheduling information, and information relating to neighboring cells providing a specific service on the MTCH.

On the other hand, as for MBS multicast, the current technical specifications of the 3GPP enable the UE 100 to receive data of multicast sessions only in the RRC connected state. When the UE 100 having joined a multicast session is in the RRC connected state and the multicast session is activated, the gNB 200 transmits an RRC reconfiguration message including a PTM configuration relating to the multicast session to the UE 100. Such a PTM configuration is also referred to as a multicast radio bearer (MRB) configuration, an MTCH configuration, or a PTM configuration. Such an MRB configuration (MRB-ToAddMod) includes an MBS session identifier (mbs-SessionId), an MRB identifier (mrb-Identity), and other parameters such as a PDCP configuration (pdcp-Config) for an MRB (multicast MRB) to be configured for the UE 100.

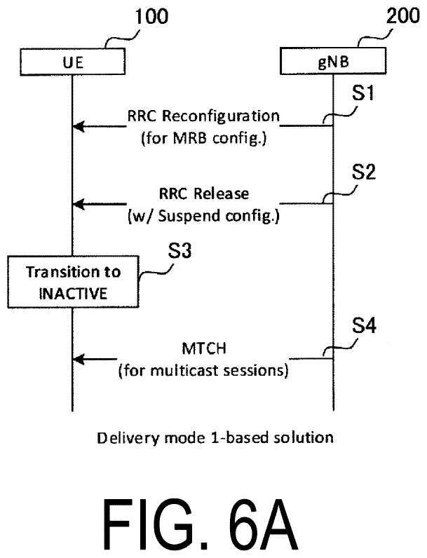

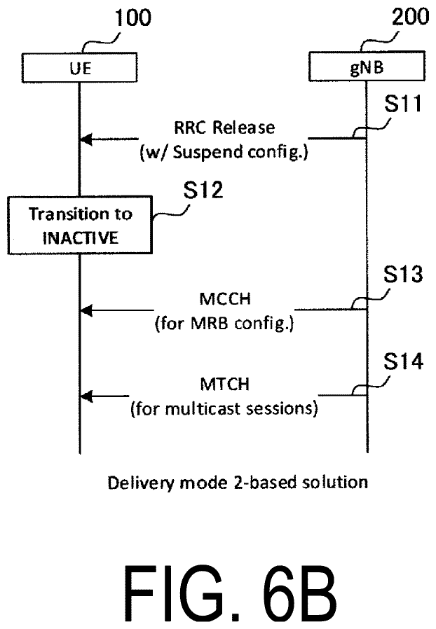

In the following embodiment, an operation of enabling the UE 100 in the RRC inactive state to perform multicast reception will be mainly described. FIGS. 6A and 6B are diagrams illustrating an overview of the operation.

As a solution for the UE 100 in the RRC inactive state to perform multicast reception, a solution based on the delivery mode 1 illustrated in FIG. 6A and a solution based on the delivery mode 2 illustrated in FIG. 6B are considered. Assume that the UE 100 supports multicast reception in the RRC inactive state and has joined a multicast session.

In the solution based on the delivery mode 1 illustrated in FIG. 6A, in step S1, the gNB 200 transmits an RRC Reconfiguration message including the MBS configuration (PTM configuration) relating to multicast sessions to the UE 100 in the RRC connected state. The UE 100 receives multicast data on the MTCH via the multicast session (multicast MRB) based on the PTM configuration received in the RRC Reconfiguration message.

In step S2, the gNB 200 transmits to the UE 100 in the RRC connected state an RRC release (Release) message for causing the UE 100 to transition to the RRC inactive state. The RRC Release message includes a configuration (Suspend Config.) for the RRC inactive state.

In step S3, the UE 100 transitions from the RRC connected state to the RRC inactive (INACTIVE) state in response to reception of the RRC Release message in step S2.

In step S4, the UE 100 in the RRC inactive state continues to use the PTM configuration in step S1 to receive the multicast data on the MTCH over the multicast session.

This enables the UE 100 in the RRC inactive state to perform multicast reception. Note that, although an example where the PTM configuration is performed using the RRC Reconfiguration message has been described, the PTM configuration may be performed using an RRC Release message.

Both the RRC Reconfiguration message and the RRC Release message are RRC messages transmitted per UE on the dedicated control channel (DCCH), and are hereinafter also referred to as dedicated RRC messages or dedicated signaling.

On the other hand, in the solution based on the delivery mode 2 illustrated in FIG. 6B, in step S11, the gNB 200 transmits to the UE 100 in the RRC connected state an RRC Release message for causing the UE 100 to transition to the RRC inactive state. The RRC Release message includes a configuration (Suspend Config.) for the RRC inactive state.

In step S12, the UE 100 transitions to the RRC inactive (INACTIVE) state in response to reception of the RRC Release message in step S11.

In step S13, the gNB 200 transmits the MCCH including the MBS configuration (PTM configuration) for the multicast session. The UE 100 receives the MCCH. Note that the UE 100 receives the SIB 20 prior to the reception of the MCCH, and receives the MCCH based on the SIB 20. Note that the MCCH transmission (and reception) may be performed before step S11 or may be performed simultaneously with step S11.

In step S14, the UE 100 in the RRC inactive state receives the multicast data on the MTCH over the multicast session based on the PTM configuration received on the MCCH in step S13. This enables the UE 100 in the RRC inactive state to perform multicast reception.

A mix solution of the solution based on the delivery mode 1 and the solution based on the delivery mode 2 is also contemplated. For example, a mix configuration method is also possible in which an initial configuration of the MBS configuration (PTM configuration) is performed through dedicated signaling and the update of the MBS configuration (PTM configuration) is performed on the MCCH.

### (3) OPERATION ACCORDING TO EMBODIMENT

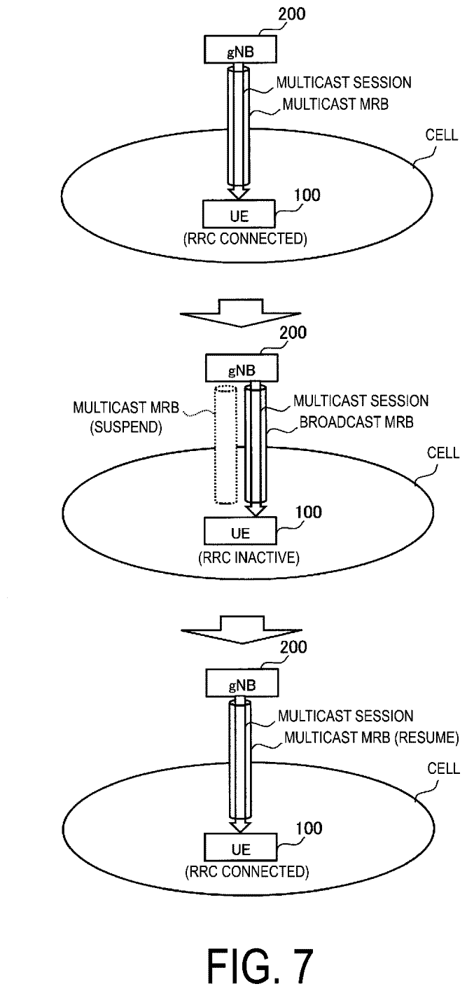

FIG. 7 is a diagram illustrating a first operation scenario according to an embodiment.

In the first operation scenario, firstly, the UE 100 in the RRC connected state in the cell of the gNB 200 establishes a multicast MRB with the gNB 200. The UE 100 in the RRC connected state receives a multicast session via the multicast MRB from the gNB 200.

Second, the UE 100 transitions from the RRC connected state to the RRC inactive state. Here, the UE 100 suspends the multicast MRB (and the PTM configuration). The suspending the multicast MRB may be stopping the use of (deactivating) the multicast MRB while maintaining the configuration of the multicast MRB.

The UE 100 establishes a broadcast MRB for multicast with the gNB 200 before transitioning to the RRC inactive state, when transitioning to the RRC inactive state, or after transitioning to the RRC inactive state. The UE 100 in the RRC inactive state receives a multicast session via the broadcast MRB for multicast from the gNB 200.

The UE 100 in the RRC connected state or the RRC inactive state may receive the PTM configuration on the MCCH from the gNB 200 and establish a broadcast MRB for multicast based on the PTM configuration. Alternatively, the UE 100 in the RRC connected state may receive a PTM configuration on the DCCH from the gNB 200 that is the same as and/or similar to the PTM configuration transmitted on the MCCH and establish a broadcast MRB for multicast based on the PTM configuration.

Note that the UE 100 may establish a multicast MRB or a new type of MRB for multicast reception in the RRC inactive state instead of the broadcast MRB for multicast. Hereinafter, the MRB established through the MCCH or information corresponding thereto (MCCH content) is also referred to as a “first MRB”.

Third, the UE 100 transitions from the RRC inactive state to the RRC connected state through an RRC connection resume procedure. Here, the UE 100 resumes the suspended multicast MRB. The UE 100 in the RRC connected state receives a multicast session from the gNB 200 by using the resumed multicast MRB (and the resumed PTM configuration). Hereinafter, the multicast MRB resumed through the RRC connection resume procedure is also referred to as a “second MRB”.

In such a first operation scenario, the UE 100 in the RRC inactive state during receiving the multicast resumes the multicast MRB (the second MRB) when transitioning to the RRC connected state. Here, the UE 100 has been using the first MRB established based on the MCCH for multicast reception in the RRC inactive state. Therefore, the multicast reception of the same multicast session needs to be switched from that via the first MRB to that via the second MRB. For example, even in the same multicast session, a change from a broadcast MRB established based on the MCCH to a multicast MRB is required.

A normal bearer type change is performed by reconfiguring a different bearer type for the same MRB configuration in ToAddModList in the RRC Reconfiguration message, i.e., the type of the MRB is modified. However, since the first MRB established based on the MCCH is not configured in ToAddModList, there is a problem that the MRB type cannot be changed.

The UE 100 holds the multicast MRB configuration by the RRC suspend, and when the multicast MRB is also resumed through the RRC connection resume, a relationship between the first MRB currently received and the resumed second MRB needs to be clarified.

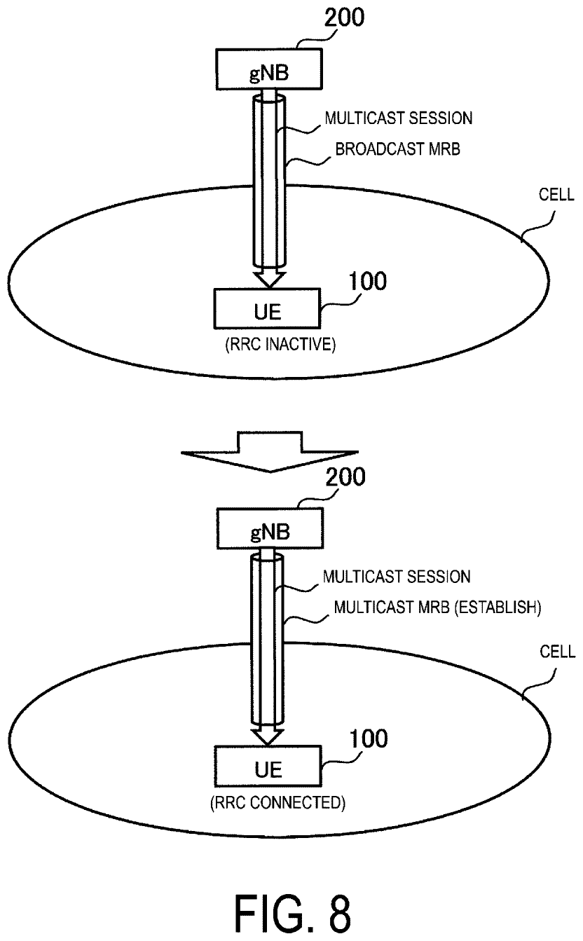

FIG. 8 is a diagram illustrating a second operation scenario according to an embodiment.

In the second operation scenario, firstly, the UE 100 in the RRC inactive state in the cell of the gNB 200 establishes a broadcast MRB for multicast (the first MRB) with the gNB 200. The first MRB may be a new type of MRB. The UE 100 in the RRC inactive state starts receiving a multicast session via the first MRB.

Second, the UE 100 transitions from the RRC inactive state to the RRC connected state through the RRC connection resume procedure. Here, the UE 100 establishes the second MRB (the multicast MRB) based on, for example, the PTM configuration in the RRC Reconfiguration message received from the gNB 200. The UE 100 in the RRC connected state receives a multicast session from the gNB 200 by using the established second MRB.

As described above, in the second operation scenario, before the UE 100 transits to the RRC inactive state, that is, when the UE 100 is in the RRC connected state, the multicast MRB is not configured and the multicast session is not started yet. Thereafter, when the UE 100 is in the RRC inactive state, a multicast session is started and the UE 100 establishes the first MRB based on the MCCH. Then, the UE 100, once transitioning from the RRC inactive state to the RRC connected state, established newly the second MRB.

Here, the UE 100 has been using the first MRB established based on the MCCH for multicast reception in the RRC inactive state. Therefore, the multicast reception of the same multicast session needs to be switched from that via the first MRB to that via the second MRB.

A normal bearer type change is performed by reconfiguring a different bearer type for the same MRB configuration in ToAddModList in the RRC Reconfiguration message, i.e., the type of the MRB is modified. However, since the first MRB established based on the MCCH is not configured in ToAddModList, there is a problem that the MRB type cannot be changed. In addition, a relationship between the first MRB currently received and the resumed second MRB needs to be clarified.

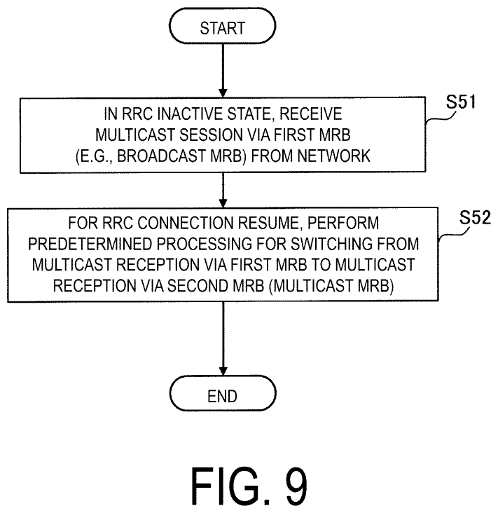

FIG. 9 is a flowchart illustrating an overview of operations according to an embodiment.

In step S51, the UE 100 in the RRC inactive state receives a multicast session via the first MRB from the network 5.

In step S52, the UE 100, when performing the RRC connection resume to transition from the RRC inactive state to the RRC connected state, performs predetermined processing of switching from reception of a multicast session via the first MRB to reception of a multicast session via the second MRB different from the first MRB.

First to fifth operation patterns according to the embodiment will be described below. the first to fifth operation patterns are different in contents of the predetermined processing. Note that the above-described first operation scenario is assumed in the first to fifth operation patterns. That is, the second MRB is a MRB suspended when the UE 100 transitions to the RRC inactive state. The predetermined processing includes processing of resuming the suspended second MRB.

Alternatively, the above-described second operation scenario may be assumed in the first to fifth operation patterns. When the second operation scenario is assumed, the predetermined processing includes processing of establishing the second MRB. In the above-described embodiment, “resume” may be read as “establish”.

### (3.1) First Operation Pattern

The first operation pattern is on the assumption that the network 5 (the gNB 200) transmits the same multicast session on the same resource (e.g., the same PDSCH) for the multicast MRB (the second MRB) and the broadcast MRB (the first MRB) when viewed from the lower layer (e.g., the physical layer). Therefore, the UE 100 receives the same MTCH, and a PDCP count value which is a variable (a PDCP variable) used in the PDCP layer is also the same regardless of whether the multicast MRB or the broadcast MRB.

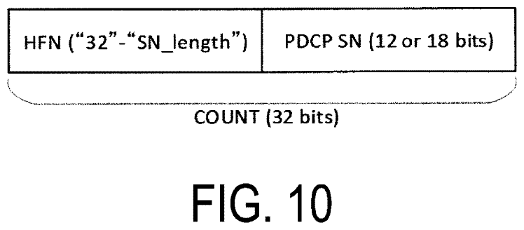

As illustrated in FIG. 10, the PDCP count value consists of a hyper frame number (HFN) that is counted up every time a PDCP sequence number makes one round and a PDCP sequence number (PDCP SN). Each of the networks 5 (the gNB 200) and the UE 100 manages the PDCP count value and updates the PDCP count value in response to transmission and reception of the PDCP packet. For example, the PDCP count value has a bit length of 32 bits, the PDCP SN has a bit length (SN_length) of 12 bits or 18 bits, and the HFN has a bit length obtained by subtracting the bit length of the PDCP SN from the bit length of the PDCP count value. Hereinafter, the PDCP variable indicates the PDCP count value, but the PDCP variable may be only one of the HFN and the SN.

In the current 3GPP technical specifications, an initial value of the PDCP count value for the multicast MRB is configured from the gNB 200 for the UE 100 in the RRC Reconfiguration message. Therefore, the UE 100, when not receiving the RRC reconfiguration message, may possibly not resume the multicast MRB (the second MRB). For the first operation pattern, an operation for smoothly resuming the multicast MRB (the second MRB) is described.

In the first operation pattern, the UE 100 in the RRC inactive state updates a PDCP variable (e.g., a PDCP count value) for the first MRB in response to packet reception of the multicast session via the first MRB (e.g., the broadcast MRB). The predetermined processing includes processing of determining a PDCP variable (e.g., an initial value of the PDCP count value) for the second MRB (the multicast MRB) based on the PDCP variable for the first MRB. For example, the UE 100 takes over the PDCP count value for the broadcast MRB upon the resume of the multicast MRB. This makes it possible to smoothly resume the multicast MRB (the second MRB).

In the first operation pattern, the UE 100 may receive, from the network 5, information indicating to perform the processing of determining the PDCP variable (e.g., the initial value of the PDCP count value) for the second MRB (the multicast MRB) based on the PDCP variable for the first MRB at a time of or before transitioning to the RRC inactive state. That is, the network 5 (the gNB 200) may configure whether to take over the PDCP count value for the UE 100. Accordingly, the network 5 can control a behavior of the UE 100 upon RRC connection resume.

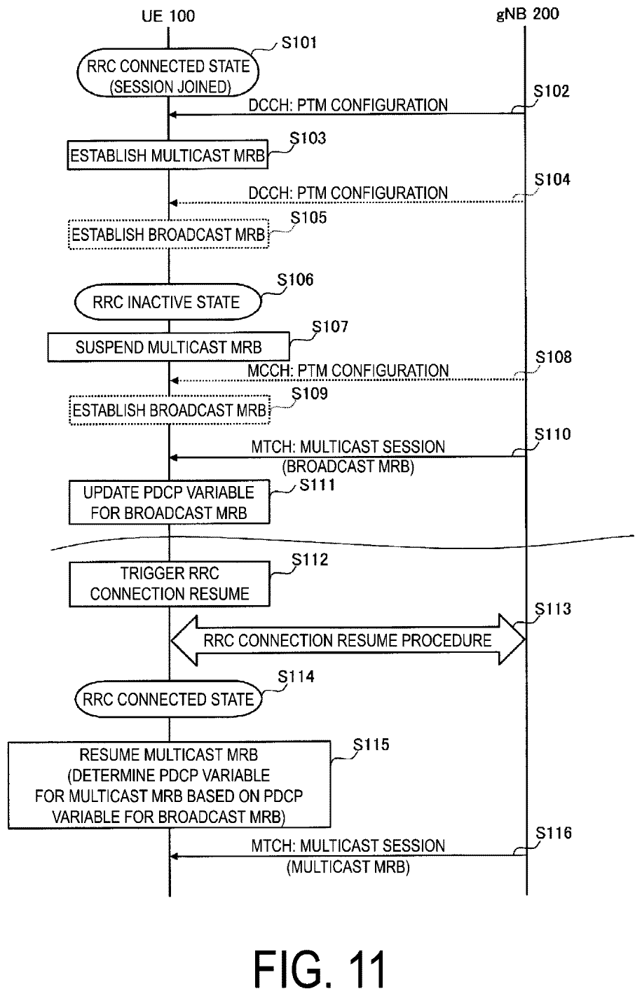

FIG. 11 is a diagram illustrating an example of the first operation pattern according to an embodiment.

In step S101, the UE 100 in the RRC connected state has already joined a multicast session (here, also referred to as a specific multicast session).

In step S102, the gNB 200 transmits a message including a PTM configuration for a specific multicast session on the DCCH to the UE 100 in the RRC connected state. That message may be an RRC Reconfiguration message or an RRC Release message. That message may include an indication of whether to take over the PDCP count value from the broadcast MRB upon the resume of the multicast MRB. In step S103, the UE 100 establishes a multicast MRB with the gNB 200 based on the PTM configuration in step S102. The UE 100 may start receiving the specific multicast session on the MTCH by using the established multicast MRB. In step S104, the gNB 200 transmits a message including a PTM configuration on the DCCH that is the same as and/or similar to the PTM configuration transmitted on the MCCH to the UE 100 in the RRC connected state. That message may be an RRC Reconfiguration message or an RRC Release message. That message may include an indication of whether to take over the PDCP count value from the broadcast MRB upon the resume of the multicast MRB. In step S105, the UE 100 establishes the broadcast MRB with the gNB 200 based on the PTM configuration in step S104, and associates the broadcast MRB with the multicast MRB. The UE 100 may start receiving the specific multicast session on the MTCH by using the established broadcast MRB. Note that steps S104 and S105 are optional operations. When operations of steps S108 and S109 to be described below are performed, steps S104 and S105 may be omitted.

In step S106, the gNB 200 transmits the RRC Release message to the UE 100 to cause the UE 100 to transition to the RRC inactive state. The UE 100 transitions from the RRC connected state to the RRC inactive state in response to reception of the RRC Release message. When the RRC Release message is used in step S102 and/or S104, the UE 100 may transition to the RRC inactive state in step S102 and/or S104. In step S107, the UE 100 suspends the multicast MRB.

In step S108, the gNB 200 may transmit the PTM configuration for the multicast session on the MCCH. In step S109, the UE 100 may establish a broadcast MRB with the gNB 200 based on the PTM configuration in step S108, and the UE 100 associating the broadcast MRB with the multicast MRB may use the established broadcast MRB to start receiving the specific multicast session on the MTCH. Note that when optional operations of steps S104 and S105 described above are performed, steps S108 and S109 may be omitted.

In step S110, the UE 100 in the RRC inactive state receives the specific multicast session via the broadcast MRB. In step S111, the UE 100 in the RRC inactive state updates (concretely, counts up) the PDCP count value in response to reception of the multicast session (concretely, reception of the PDCP packet).

Thereafter, in step S112, the UE 100 receiving the multicast session in the RRC inactive state triggers resume of an RRC connection. For example, the UE 100 may trigger the resume of the RRC connection through the occurrence of a RAN paging message or a mobile originated (MO) call.

In step S113, the UE 100 performs the RRC connection resume procedure with the gNB 200. The RRC connection resume procedure includes transmitting an RRC resume request message from the UE 100 to the gNB 200 and transmitting an RRC resume message from the gNB 200 to the UE 100. In step S114, the UE 100 transitions from the RRC inactive state to the RRC connected state.

In step S115, the UE 100 resumes the multicast MRB in conjunction with the resume of the RRC connection. Here, the UE 100 takes over the current PDCP count value for the broadcast MRB to the multicast MRB. That is, the UE 100 configures an initial value of the PDCP variable for the multicast MRB based on the current PDCP count value.

In step S116, the UE 100 resumes the multicast MRB and receives the specific multicast session on the MTCH via the resumed multicast MRB.

### (3.2) Second Operation Pattern

In the second operation pattern, the UE 100 in the RRC inactive state updates a PDCP variable (e.g., a PDCP count value) for the first MRB in response to packet reception of the specific multicast session via the first MRB (e.g., the broadcast MRB). The predetermined processing includes processing of transmitting a notification based on the PDCP count value for the first MRB to the network 5 (the gNB 200). This enables the network 5 (the gNB 200) to understand a situation of the PDCP variable for the UE 100 in the RRC inactive state, and transmit, for example, an unreceived PDCP packet of the first MRB for the UE 100 to the UE 100 via the second MRB. Alternatively, the network 5 (the gNB 200) may transmit, to the UE 100, a configuration or indication of switching from the broadcast MRB to the multicast MRB based on the understood situation of the PDCP variable.

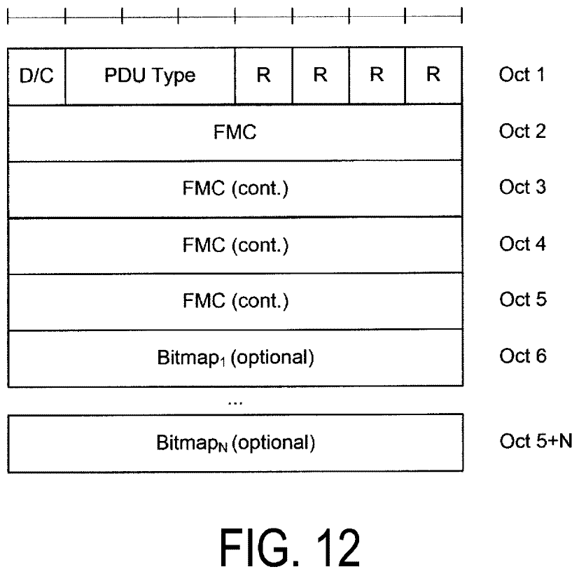

In the second operation pattern, the second MRB (the multicast MRB) may be an acknowledged mode (AM) MRB. The UE 100 may transmit a PDCP status report as the notification to the network 5 (the gNB 200). FIG. 12 is a diagram illustrating a configuration example of the PDCP status report. The PDCP status report includes, as main components, a “D/C” field having a 1-bit length, a “protocol data unit (PDU) Type” field having a 3-bit length, a “first missing COUNT (FMC)” field having a 32-bit length, and a “Bitmap” field having a variable bit length. The “D/C” field is a field indicating whether this PDCP PDU is a PDCP Data PDU or a PDCP Control PDU. The PDCP status report corresponds to the PDCP Control PDU. The “PDU Type” field is a field indicating whether this PDCP Control PDU is a “PDCP status report”, “Interspersed ROHC feedback”, or “EHC feedback”. The “first missing COUNT (FMC)” field is a field indicating a count value (COUNT) of a first missing PDCP SDU in a reordering window. Note that the count value (COUNT) includes the HFN and the PDCP SN. The “Bitmap” field is a field indicating a missing PDCP SDU and a PDCP SDU successfully received at a receiving PDCP entity. Specifically, the “Bitmap” field indicates a reception status of the PDCP SDU from the FMC onwards as “0” (missing) or “1” (successfully received).

In the second operation pattern, the UE 100 may transmit a notification including the latest PDCP count value for the first MRB (the multicast MRB) as the notification to the network 5 (the gNB 200).

### (3.2.1) Example of Second Operation Pattern

In an example of the second operation pattern according to the embodiment, the UE 100, when resuming the AM MRB, transmits a PDCP status report to the gNB 200.

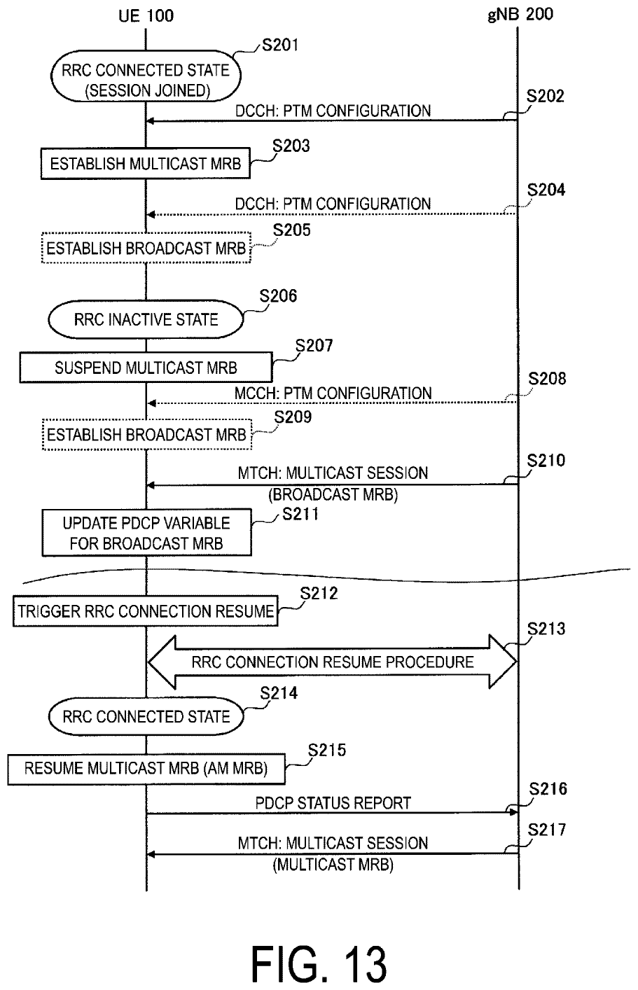

FIG. 13 is a diagram illustrating an example of the second operation pattern according to an embodiment.

The operations in steps S201 to S214 are the same as and/or similar to the operations in steps S101 to S114 of FIG. 11. However, in this operation example, the multicast MRB is an AM MRB. The gNB 200 may preconfigure the UE 100 with whether to transmit the PDCP status report upon the resume of the AM MRB in step S202, S204, or S208.

In step S216, the UE 100 in the RRC connected state transmits the PDCP status report to the gNB 200. The UE 100 may identify the SN of the unreceived packet (or may identify the SN of the latest packet successfully received) based on the PDCP count value for the broadcast MRB used for reception of the specific multicast session, and transmit the PDCP status report from (a PTP leg of) the multicast MRB to the gNB 200. The gNB 200 receives the PDCP status report.

In step S217, the gNB 200 retransmits the unreceived packet to the UE 100 by using the PTP leg (or a PTM leg) of the resumed multicast MRB.

### (3.2.2) Another Example of Second Operation Pattern

In another example of the second operation pattern according to the embodiment, when the multicast MRB (the second MRB) is resumed, the UE 100 notifies the gNB 200 of the (latest) PDCP count value received in the broadcast MRB (the first MRB).

In this operation example, the PDCP count values for the multicast MRB and the broadcast MRB may be different from each other. The MRB switching can be facilitated by conveying information from the UE 100 to the gNB 200 as to until which packet the UE 100 has successfully received via the broadcast MRB (i.e., which the gNB 200 sets as an initial packet of the multicast MRB).

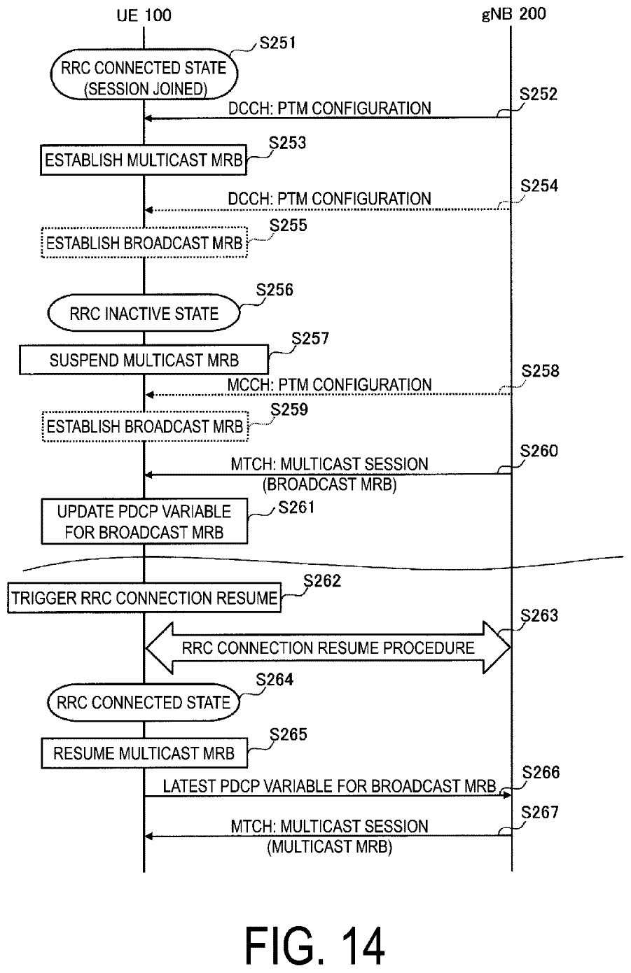

FIG. 14 is a diagram illustrating another example of the second operation pattern according to an embodiment.

The operations in steps S251 to S264 are the same as and/or similar to the operations in steps S101 to S114 of FIG. 11. However, in the present operation example, the PDCP count values for the broadcast MRB (the first MRB) and the multicast MRB (the second MRB) may not need to be synchronized with each other. For example, the gNB 200 may transmit the broadcast MRB (the first MRB) and the multicast MRB (the second MRB) on physically separate MTCHs (PDSCHs).

In step S265, when the UE 100 resumes the RRC connection, the UE 100 resumes the multicast MRB for the specific multicast session the UE 100 is receiving.

In step S266, the UE 100 notifies the gNB 200 of the (last or latest) PDCP count value (sequence value) successfully received in the broadcast MRB. The notification may be made using a PDCP status report which is a type of PDCP control PDU. The notification may be made using a UE Assistance Information message which is a type of RRC message. The PDCP count value in the notification does not correspond to the multicast MRB, but corresponds to the broadcast MRB (that is, another bearer). The gNB 200 receives the notification. The gNB 200 takes the notification into account to identify the initial packet of the data via the multicast MRB.

In step S267, the gNB 200 transmits the multicast session on the MTCH via the multicast MRB to the UE 100 in the RRC connected state. The UE 100 receives the multicast session.

### (3.3) Third Operation Pattern

When the UE 100 in the RRC inactive state receiving the specific multicast session transitions to the RRC connected state, a multicast MRB may be configured for the specific multicast session through an RRC reconfiguration message. In this case, there is a problem that a timing is not clarified at which the reception operation of the UE 100 is switched from the broadcast MRB (the first MRB) to the multicast MRB (the second MRB).

In the third operation pattern, the predetermined processing includes stopping the multicast reception via the first MRB when the second MRB is resumed. That is, when the multicast MRB used for the reception of the specific multicast session is resumed, the UE 100 stops the reception of the broadcast MRB that is being used for receiving the specific multicast session. Here, the stopping of receiving the broadcast MRB may be the MTCH reception stopping and/or the MCCH reception.

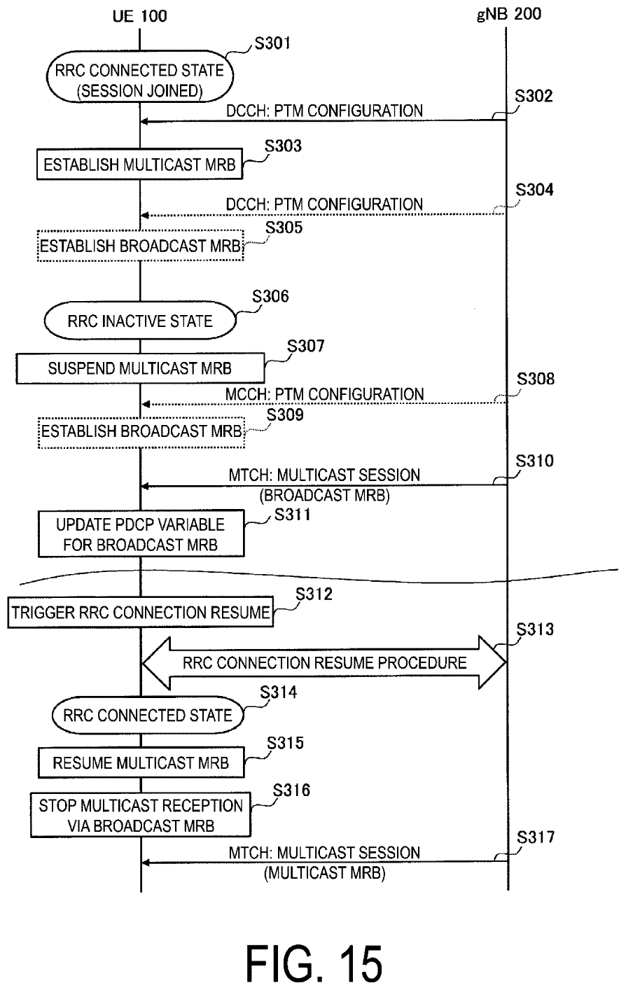

FIG. 15 is a diagram illustrating an example of the third operation pattern according to an embodiment.

The operations in steps S301 to S314 are the same as and/or similar to the operations in steps S101 to S114 of FIG. 11.

In step S315, when the UE 100 resumes the RRC connection, the UE 100 resumes the multicast MRB for the specific multicast session the UE 100 is receiving in the broadcast MRB (the first MRB).

In step S316, the UE 100 in the RRC connected state detects that a plurality of MRBs (a broadcast MRB and a multicast MRB) are established in the specific multicast session, and gives priority to reception in the multicast MRB. For example, the UE 100 may discard the broadcast MRB. Alternatively, the UE 100 may stop the reception operation via the broadcast MRB without discarding the broadcast MRB. The UE 100 may perform such an operation after reception in the multicast MRB is started (e.g., when reception is performed without any problem or when reception is started successfully).

In step S317, the UE 100 receives the specific multicast session on the MTCH via the multicast MRB (the second MRB).

### (3.4) Fourth Operation Pattern

When the PDCP count values for the broadcast MRB (first MRB) and the multicast MRB (second MRB) are not synchronized with each other, for example, when these are transmitted on physically different MTCHs (PDSCHs), the PDCP count value for the multicast MRB is indefinite when viewed from the UE 100 upon the RRC connection resume.

In the technical specifications of 3GPP Release 17, a mechanism is introduced in which the initial values of the variables (HFN and SN) of the PDCP entity associated with the multicast MRB are explicitly reported from the gNB 200 to the UE 100 in the RRC Reconfiguration message. In the third operation pattern, the UE 100 switches the reception from the broadcast MRB (the first MRB) to the multicast MRB (the second MRB) in response to the initial value of the PDCP variable being reported from the gNB 200 to the UE 100.

In the third operation pattern, the predetermined processing includes processing of starting multicast reception via the second MRB and/or stopping multicast reception via the first MRB when the UE 100 is notified of initial value information indicating the initial value of the PDCP variable used in the second MRB by the network 5 (the gNB 200). That is, when the multicast MRB is resumed and the UE 100 is notified of the initial value of the PDCP variable by the gNB 200, the UE 100 starts the reception in the multicast MRB and/or stops the reception in the broadcast MRB.

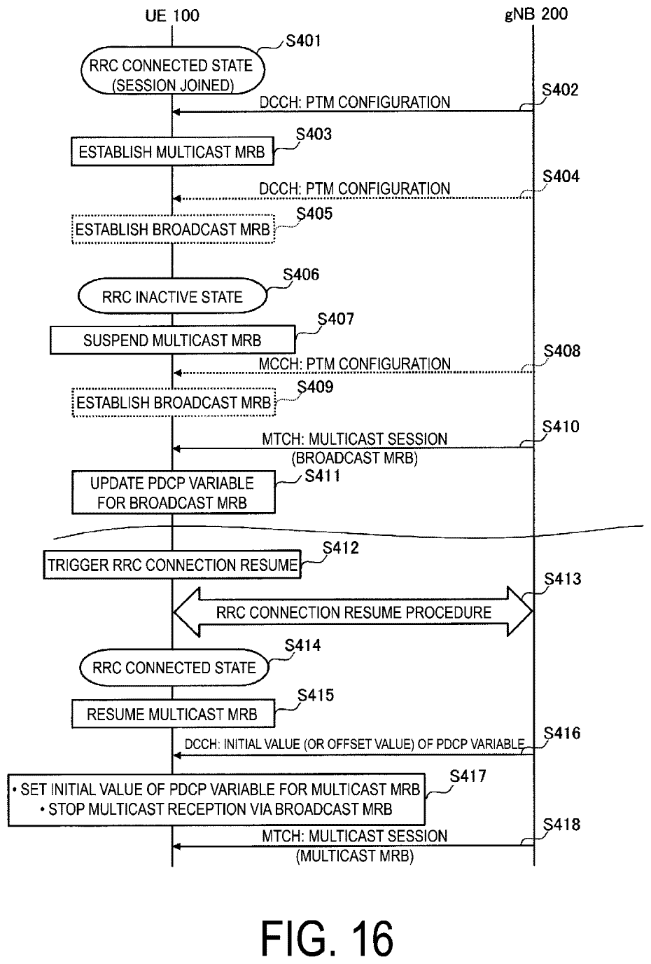

FIG. 16 is a diagram illustrating an example of the fourth operation pattern according to an embodiment.

The operations in steps S401 to S414 are the same as and/or similar to the operations in steps S101 to S114 of FIG. 11.

In step S415, when the UE 100 resumes the RRC connection, the multicast MRB is resumed for the specific multicast session that is being received in the broadcast MRB (the first MRB). However, the UE 100 in the RRC connected state continues to receive the specific multicast session via the broadcast MRB.

In step S416, the gNB 200 transmits, to the UE 100, the initial values of the PDCP variables (PDCP count value, HFN and/or PDCP SN) for the resumed multicast MRB on the DCCH (e.g., in the RRC Reconfiguration message). The gNB 200 may further notify the UE 100 of information of the MRB to which the initial value of the PDCP variable is to be applied, such as an MRB ID, and/or information indicating that the initial value of the PDCP variable is to be applied to a multicast MRB.

In step S417, the UE 100 in the RRC connected state sets the initial value. The UE 100 may stop (and discard) the multicast reception via the broadcast MRB.

In step S418, the UE 100 receives the specific multicast session on the MTCH via the multicast MRB (the second MRB).

Note that, in step S416, the gNB 200 may report a difference (offset) between the PDCP count value for the multicast MRB (the second MRB) and the PDCP count value for the broadcast MRB (the first MRB). That is, the initial value information transmitted from the gNB 200 to the UE 100 in step S416 may be offset information related to the difference between the initial value of the PDCP variable for the first MRB and the initial value of the PDCP variable used in the second MRB. This can reduce the number of bits of the initial value information compared to the reporting of the initial value of the PDCP variable used in the second MRB as it is as the initial value information. In this case, in step S417, the UE 100 may determine the PDCP count value for the multicast MRB (the second MRB) by adding the reported difference value to the PDCP count value for the broadcast MRB (the first MRB).

### (3.5) Fifth Operation Pattern

In the fifth operation pattern, the predetermined processing includes processing of receiving, from the network 5, an indication of switching that indicates switching from the first MRB (the broadcast MRB) to the second MRB (the multicast MRB). That is, the switching of the MRB from the broadcast MRB to the multicast MRB is explicitly indicated to the UE 100 by the gNB 200.

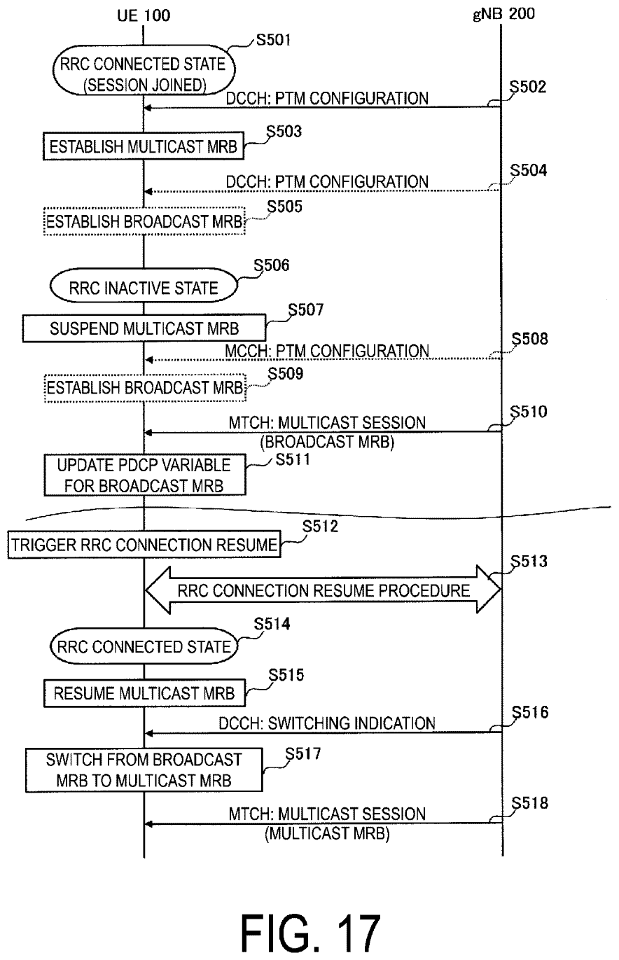

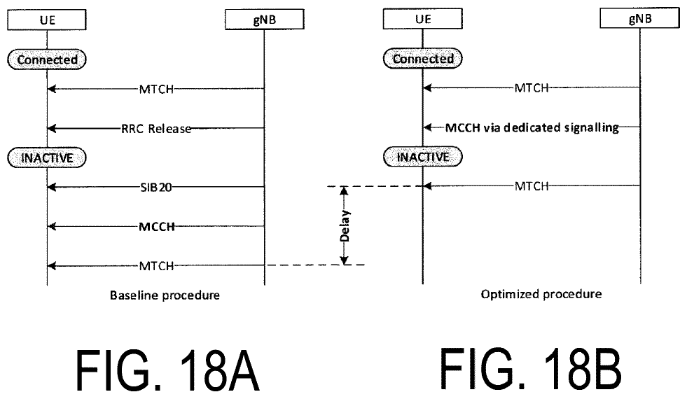

FIG. 17 is a diagram illustrating an example of the fifth operation pattern according to an embodiment.

The operations in steps S501 to S514 are the same as and/or similar to the operations in steps S101 to S114 of FIG. 11.

In step S515, when the UE 100 resumes the RRC connection, the UE 100 resumes the multicast MRB for the specific multicast session the UE 100 is receiving in the broadcast MRB.

In step S516, the gNB 200 transmits an indication of switching the MRB used for the reception of the specific multicast session (switching to the multicast MRB) on the DCCH (e.g., in the RRC Reconfiguration message) to the UE 100. The indication may include an MBS session ID of the specific multicast session and/or the MRB ID of the multicast MRB.

Here, the gNB 200 may be assumed to wish that the reception via the broadcast MRB is to be continued when, for example, the PTM transmission for the multicast MRB is not yet prepared (when only the PTP transmission is performed). In such a case, the gNB 200 indicates switching to reception in the multicast MRB when the PTM transmission in the multicast MRB is started.

In step S517, the UE 100 in the RRC connected state changes a reception path of the specific multicast session to the multicast MRB in response to the indication in step S516. Here, the UE 100 may stop the reception in the broadcast MRB (and discard the broadcast MRB).

In step S518, the UE 100 receives the specific multicast session on the MTCH via the multicast MRB (the second MRB).

### (4) OTHER EMBODIMENTS

Although the multicast reception in the RRC inactive state has been mainly described in the above-described embodiments, the operations according to the above-described embodiments may also be applied to multicast reception in the RRC idle state. With respect to the RRC idle state, the RRC resume described above can be read as RRC establishment. For example, in 3GPP Release 19 and subsequent versions, when the UE 100 in the RRC idle state becomes able to receive the multicast session, the multicast MRB is established after the RRC connection (configured through the RRC Reconfiguration message).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (5) SUPPLEMENTARY NOTE

### Supplementary Note 1

A communication method used in a mobile communication system for providing a multicast/broadcast service (MBS), the communication method including the steps of:
receiving, by a user equipment in a radio resource control (RRC) inactive state, a multicast session via a first multicast radio bearer (MRB) from a network; and
performing, by the user equipment, predetermined processing of switching from reception of the multicast session via the first MRB to reception of the multicast session via a second MRB different from the first MRB, when the user equipment performs RRC connection resume to transition from the RRC inactive state to an RRC connected state.

### Supplementary Note 2

The communication method according to supplementary note 1, wherein
the second MRB is an MRB suspended when the user equipment transitions to the RRC inactive state, and
the performing of the predetermined processing includes resuming the suspended second MRB.

### Supplementary Note 3

The communication method according to supplementary note 1 or 2, further including:
updating, by the user equipment in the RRC inactive state, a PDCP variable for the first MRB in response to packet reception of the multicast session via the first MRB,
wherein the performing of the predetermined processing includes performing processing of determining a PDCP variable for the second MRB, based on the PDCP variable for the first MRB.

### Supplementary Note 4

The communication method according to supplementary note 3, further including:
receiving, by the user equipment, information indicating to perform the processing of determining from the network at a time of or before transitioning to the RRC inactive state.

### Supplementary Note 5

The communication method according to any one of supplementary notes 1 to 4, further including:
updating, by the user equipment in the RRC inactive state, a PDCP variable for the first MRB in response to packet reception of the multicast session via the first MRB,
wherein the performing of the predetermined processing includes transmitting a notification based on a PDCP count value for the first MRB to the network.

### Supplementary Note 6

The communication method according to supplementary note 5, wherein
the second MRB is an acknowledged mode (AM) MRB, and
the transmitting of the notification includes transmitting a PDCP status report as the notification to the network.

### Supplementary Note 7

The communication method according to supplementary note 5 or 6, wherein
the transmitting of the notification includes transmitting the notification comprising the latest PDCP count value for the first MRB to the network.

### Supplementary Note 8

The communication method according to any one of supplementary notes 1 to 7, wherein
the performing of the predetermined processing includes stopping multicast reception via the first MRB when the second MRB is resumed or established.

### Supplementary Note 9

The communication method according to any one of supplementary notes 1 to 8, wherein
the performing of the predetermined processing includes starting multicast reception via the second MRB and/or stopping multicast reception via the first MRB when the user equipment is notified of initial value information indicating an initial value of a PDCP variable used in the second MRB from the network.

### Supplementary Note 10

The communication method according to supplementary note 9, wherein
the initial value information is offset information related to a difference between an initial value of a PDCP variable for the first MRB and an initial value of a PDCP variable used for the second MRB.

### Supplementary Note 11

The communication method according to any one of supplementary notes 1 to 10, wherein
the performing of the predetermined processing includes receiving, from the network, an indication of switching that indicates switching from the first MRB to the second MRB.

### Supplementary Note 12

A user equipment used in a mobile communication system for providing a multicast/broadcast service (MBS), the user equipment including:
a receiver configured to receive, in a radio resource control (RRC) inactive state, a multicast session via a first multicast radio bearer (MRB) from a network; and
a controller configured to perform predetermined processing of switching from reception of the multicast session via the first MRB to reception of the multicast session via a second MRB different from the first MRB, when the user equipment performs RRC connection resume to transition from the RRC inactive state to an RRC connected state.

### (6) SUPPLEMENTARY NOTES

### 1. Introduction

The work items for enhancing the MBS (eMBS) are intended to support the multicast reception by the UE in the inactive state as follows.

To define support for the multicast reception by the UE in the RRC inactive state [RAN 2, RAN 3] A PTM configuration for the UE that receives the multicast in the RRC inactive state [RAN 2] Investigation of the impact of mobility and state transition of the UE receiving the multicast in the RRC inactive state (seamless/lossless mobility is not a requirement) [RAN 2, RAN 3]
RAN 2 has discussed this purpose and reached a series of agreements.
Based on these agreements, The PTM configuration and mobility aspect for the multicast reception in the inactive state are discussed in this supplementary note.

### 2. Discussion

### 2.1 PTM Configuration Delivery

Rel-17 defines two delivery modes of a mode called “delivery mode 1” for a multicast session and a mode called “delivery mode 2” for a broadcast session. While, in the delivery mode 1, reception on the MTCH is configured with RRC reconfiguration only for UE in the connected state, in the delivery mode 2, reception on the MTCH is configured with the MCCH for all the UEs in the RRC state.

RAN 2 #119e has defined that these delivery modes are candidates for the multicast reception in the inactive state, i.e., option 1, option 2, and “MIX” of these options.

For the PTM configuration delivery, RAN 2 further studies the following solutions.
Option 1: Dedicated signaling
Option 2: Solution based on SIB+MCCH
“MIX” of options is not excluded.

RAN 2 #120 has reached an agreement to advance the “mixed approach”.

The mixed approach is included and start as follows.
1. When the NW configures the UE to continue multicast reception in the inactive state, the NW provides the PTM configuration for the activated multicast session through RRC dedicated signaling to at least the serving cell (other cases need to be further studied).
2. The MCCH is used when the PTM configuration needs to be changed or when the PTM configuration needs to be indicated during transition beyond the serving cell/gNB. The state change during the session and other indications need to be further studied.
3. Assume that the UE can receive the multicast service after joining the session.
4. Whether the MCCH configuration is initially provided to the UE through the dedicated signaling needs to be further studied.

According to the above agreement item #1, the network configures the PTM configuration of the activated multicast session for the UE through the dedicated signaling. Since the multicast session is activated, the connected UE has already received the multicast session and is assumed to be able to continue receiving the multicast session after the UE transitions to inactive according to this PTM configuration.

In the present disclosure, the “mixed approach” agreed by RAN 2 means that the MCCH is used for updating the PTM configuration, etc., and thus, is close to the delivery mode 2 of Rel-17. In this sense, the dedicated signaling only provides the content of the MCCH (such as MBS Broadcast Configuration) rather than the Rel-17 dedicated multicast configuration (such as mrb-ToAddModList). Such dedicated signaling is useful to prevent the UE from monitoring the MCCH in the connected state and to minimize service interruption due to delayed MCCH acquisition after transitioning to the inactive state.

Proposal 1: RAN 2 should agree that dedicated signaling provides the content of the MCCH (i.e., MBS Broadcast Configuration) for the multicast reception in the inactive state.

On the other hand, since RAN 2 has agreed that the UE in the inactive state can start receiving the multicast session, that is, scenario 2 with the following agreement items is agreed, what can be configured for the inactivated multicast session is not clear.

In Rel-18, the multicast reception for the UE in the inactive state supports at least the following scenarios, based on the premise that the UE has already a valid PTM configuration.
Scenario 1: The UE receives multicast in the connected state, enters the inactive state, and continues the multicast reception.
Scenario 2: The UE joins a multicast session and is directed to the inactive state, and the UE starts receiving the multicast session.
   The state change, such as a state change due to a service that is not provided in the inactive state, needs to be further studied.

The actual PTM configuration may not be provided for the inactivated multicast session, but may be provided once the multicast session is activated. In Rel-17, the UE in the inactive state transitions to the connected state upon receiving group paging for activating the multicast session. Therefore, some kind of indication may be provided through dedicated signaling in advance to allow the UE remaining in the inactive to use the PTM configuration acquired from the MCCH for the multicast session. Another approach is that such indication is provided by group paging as discussed in the following section.

Proposal 2: RAN 2 should discuss whether some kind of configuration is provided through dedicated signaling when the UE transitions to the inactive state before activating the multicast session.

The agreement item #2 above, i.e. the MCCH is used when the PTM configuration needs to be changed or when the PTM configuration needs to be indicated during transition beyond the serving cell/gNB. The session status changing and other indications are somewhat ambiguous. That is, whether the MCCH is used for indication or for providing the PTM configuration is ambiguous. Only for the indication, MCCH Change Notification may be meant. However, the MCCH provides the PTM configuration, e.g., updates the PTM configuration of the UE in the inactive state.

Proposal 3: RAN 2 should clarify whether the MCCH provides the PTM configuration to the multicast session of the UE in the inactive state, for example, when the PTM configuration is updated.

RAN 2 leaves “whether the MCCH configuration is initially provided to the UE through dedicated signaling” as an item required to be studied. The MCCH configuration means the SIB 20. Since the dedicated signaling provides the PTM configuration for the multicast reception in the inactive state as agreed by RAN 2, the UE does not need to read the MCCH immediately and the UE does not need to know which the SIB 20, i.e. the MCCH configuration, is. Of course, the UE later acquires the SIB 20 and the MCCH to confirm whether the PTM configuration has been updated.

Proposal 4: RAN2 should agree that the MCCH configuration (i.e., the SIB 20) does not need to be provided through dedicated signaling.

### 2.2. UE Mobility and Service Continuity

RAN 2 #120 has agreed that the MCCH is used during the UE transition.

The present disclosure has the mixed approach and starts as follows.
1. When the NW configures the UE to continue multicast reception in the inactive state, the NW provides the PTM configuration for the activated multicast session through RRC dedicated signaling to at least the serving cell (other cases need to be further studied).
2. The MCCH is used when the PTM configuration needs to be changed or when the PTM configuration needs to be indicated during transition beyond the serving cell/gNB. The state change during the session and other indications need to be further studied.
3. Assume that the UE can receive the multicast service after joining the session.
4. Whether the MCCH configuration is initially provided to the UE through the dedicated signaling needs to be further studied.

The WID states that seamless/lossless mobility is not required.

To define support for the multicast reception by the UE in the RRC inactive state [RAN 2, RAN 3] A PTM configuration for the UE that receives the multicast in the RRC inactive state [RAN 2] To investigate the impact of mobility and state transition of the UE receiving the multicast in the RRC inactive state (seamless/lossless mobility is not a requirement) [RAN 2, RAN 3]

As described in section 2.1., the delivery method of the new PTM configuration is similar to the delivery mode 2 of Rel-17. Therefore, it is natural to take the service continuation mechanism of Rel-17 MBS broadcast as a baseline. In this case, in the multicast session, it is necessary that neighbor cell information is first provided from the MCCH to confirm that the UE is permitted to prioritize the MBS frequency at the time of cell reselection.

It is up to the UE implementation how to ensure service continuity, as assumed in LTE SC-PTM and NR MBS broadcast. For example, how to use the neighbor cell information, whether to prioritize the MBS frequency, how/timing to acquire the MCCH from the neighbor cell, etc. are up to the UE implementation.

Proposal 5: RAN 2 should agree that the neighbor cell information of the multicast session is provided by the MCCH, in the same and/or similar way for the MBS broadcast.

Proposal 6: RAN 2 should agree that the UE is permitted to prioritize the MBS multicast frequency at the time of cell reselection, in the same and/or similar way for the MBS broadcast.

Some companies propose to enhance the service continuity during the UE transition by enabling the PTM configuration in a plurality of cells. The PTM configurations for the respective cells can be easily matched (if necessary) for the intra-gNB, but difficult for the inter-gNB and negotiation involving the Xn-AP is required. This small extension is not considered harmful for the intra-gNB with limitation. Therefore, RAN 2 needs to discuss whether the PTM configuration can be applied to a plurality of intra-gNB cells.

Proposal 7: RAN 2 should study whether the PTM configuration can be applied to a plurality of intra-gNB cells. In this case, an intra-gNB scenario is the basic assumption.

Another consideration is QoS control by the network. The WID states that the seamless/lossless mobility is not required, but this does not mean that all multicast sessions that the UE can receive in the inactive state require no seamless/lossless mobility. For example, due to congestion, the network needs to cause the UE to the inactive state, but due to QoS requirements, the UE needs to transition after connected. For the seamless/lossless mobility, handover in the RRC connection is supported in Rel-17 MBS multicast. Therefore, the network may need the option to control whether to cause the UE to perform the cell reselection or to resume the RRC connection before the cell reselection (for the handover in the connected state).

Proposal 8: RAN 2 should discuss whether the gNB can indicate whether the UE is permitted to perform inactive mode mobility before the cell reselection or to resume the RRC connection for better QoS control.

### (7) SUPPLEMENT

### 1. Introduction

The work items for enhancing the MBS (eMBS) are as follows.

To specify support for the multicast reception by the UE in the RRC inactive state [RAN 2, RAN 3] A PTM configuration for the UE that receives the multicast in the RRC inactive state [RAN 2] To investigate the impact of mobility and state transition for the UE receiving the multicast in the RRC inactive state (seamless/lossless mobility is not a requirement) [RAN 2, RAN 3]

Based on these agreements, the notification and RRC state transition aspects for the multicast reception in the inactive state are discussed in this supplementary note.

### 2. Discussion

RAN 2 #119e leaves an aspect relating to the RRC state change as an item required to be studied.

In Rel-18, the multicast reception for the UE in the inactive state supports at least the following scenarios, based on the premise that the UE has already a valid PTM configuration.
Scenario 1: The UE receives multicast in the connected state, enters the inactive state, and continues the multicast reception.
Scenario 2: The UE joins a multicast session and is directed to the inactive state, and the UE starts receiving the multicast session.
   The state change, such as changing due to a service that is not provided in the inactive state, needs to be further studied.

A plurality of cases relating to the RRC state change are considered from viewpoints of the network and the UE. Some of the cases also relate to the notification transmitted from the network to the UE. Therefore, the following cases are considered.

### 2.1. Case 1: Inactivation/Release of Multicast Session

The UE is notified of agreed RAN 2 #119bis-e when the multicast session is inactivated, and the Rel-17 mechanism is applicable when the multicast session is released.

When the UE is in the RRC inactive state and is configured to receive the multicast session in the RRC inactive state, the UE is notified when the multicast session is inactivated. For example, the notifying via group paging, an MCCH, or other methods need to be further studied. The Rel-17 mechanism (NAS-based indication) is applicable for multicast session release. Further study is provided as needed.

When the UE in the inactive state receives the MBS service, and in response to this, the gNB can stop transmission of the PTM/MTCH, the multicast session is considered to be inactivated or released. In this case, assume that the UE has no reason for continuing to monitor the MTCH, but the UE does that as long as the PTM configuration is not removed. In terms of power saving of the UE, the monitoring the MTCH is desired to be stopped as soon as possible.

Observation 1: The UE continuing to monitor the PTM/MTCH even after the multicast session is stopped or released is inefficient from the viewpoint of power consumption of the UE.

Therefore, the behavior of the UE when the multicast session is inactivated should be clarified, i.e. the UE should be permitted to stop monitoring the MTCH when receiving a notification to inactivate the multicast session, regardless of how the notification is given. The UE, when receiving such a notification, should remain in the RRC inactive state.

Proposal 1: RAN 2 should agree that the UE, upon receiving a multicast session release notification, is permitted to stop monitoring the MTCH.

For the stopping of the multicast session, RAN 2 leaves the method of notifying the UE, such as the group paging, the MCCH, or other methods, as an item required to be studied.

According to LTE SC-PTM, to give a notification that the UE stops monitoring a PDCCH of a G-RNTI, an SC-PTM Stop Indication MAC CE is introduced, and the MAC CE is multiplexed on an SC-MTCH associated with the G-RNTI. This lightweight signaling may function under restriction of a one-to-one mapping between the TMGI and the G-RNTI. On the other hand, since many-to-one mapping between the TMGI and the G-RNTI is permitted for an NR MBS, the inactivated TMGI needs to be indicated when the MAC CE is introduced. Since the MAC CE is transmitted together with the MTCH, delay from reception of the last multicast data to stop of the MTCH monitoring is expected to be minimized.

Another option is to reuse the group paging. The group paging is used to simultaneously page a plurality of UEs in a group using the TMGI instead of a UE-ID. Since the existing paging group list (i.e., a list of TMGIs) can be applied to legacy UEs, the group paging needs to add a new TMGI list for deactivation notification to avoid an influence on the legacy UEs. That is, a delay occurs from when the last multicast data is receive until when the MTCH monitoring is stopped based on an I-DRX cycle.

The third option is to reuse the MCCH. There are two possibilities for the method of notifying of inactivation of the multicast session: deleting the PTM configuration of the inactivated TMGI or adding a new indication for notifying of the inactivated TMGI. In any case, since the MCCH needs to be updated, an MCCH change notification needs to be transmitted to the UE in advance. Hence, a longer delay is required from when the last multicast data is received until when the MTCH monitoring is stopped.

According to the RAN 2 agreement that “the MCCH is used when the PTM configuration needs to be changed”, it can be interpreted that the UE in the inactive state needs to wake up at the timing of the MCCH, and the inactivation of the multicast session is regarded as a kind of “change of PTM configuration”. Thus, when the corresponding PTM configuration is deleted from the MCCH, the UE may be aware that the multicast session has been inactivated. However, it takes time for the UE to stop monitoring the MTCH. Therefore, a notification by the MAC CE is desirable.

In summary, the delay from when the last multicast data is received until when the MTCH monitoring is stopped may directly affect an increase in unnecessary power consumption of the UE. From the viewpoint of power saving of the UE, the first option of using the MAC CE is a desirable solution since the notification needs to be transmitted as soon as possible.

Proposal 2: RAN 2 should agree that when the multicast session becomes inactive, the UE in the inactive state is notified of a new MAC CE (like the existing SC-PTM Stop Indication).

As for release of the multicast session, an NAS-based indication of Rel-17 agreed by RAN 2 applies, which may be “release of a multicast session requested by the network or release of the MBS session”. This procedure assumes that the UE is paged by the gNB and transitions to the RRC connected state to communicate with the AMF. In this procedure, assume that existing group paging (or known dedicated paging) can be reused.

However, for optimization, when the new MAC CE is introduced for notification of the multicast session deactivation as in Proposal 2, this procedure can be freely used. That is, the gNB transmits the MAC CE to permit the UE to stop monitoring the MTCH, after that the gNB can distribute the timing of the pages to the UE, i.e., use legacy dedicated paging to avoid signaling storms caused by transitioning simultaneously to the RRC state.

Proposal 3: RAN 2 needs to agree that function extension specialized in multicast session release is not necessary, i.e., the UE transitions to the RRC connected state by existing (group) paging.

### 2.2. Case 2: Selective Transition Upon Activation of Multicast Session

RAN 2 #119e has reached the following agreement relating to case 2.

The gNB determines whether the UE can receive a multicast session in the inactive state. What information is to be provided (in relation to the discussion of SA2) to the gNB to make such determination needs to be further studied.
It is supported that the gNB transmits one multicast session to UEs both in the connected state and the inactive state in the same cell. How the gNB configures this support needs to be further studied.
It is assumed that the network can select which UE would receive in the RRC inactive state and which UE would receive in the RRC connected state, and can cause the UE to transition between states for reception of the multicast service.

To release the UE to be inactive, the gNB may select the UE to release in the same manner as the current, that is, in RRC Release with Suspend Config., based on UE capabilities, UE assistance information, and/or CN assistance information (when defined). Therefore, with respect to RRC release messages, no enhancement for selective transitions of the UE is foreseen.

Observation 2: Existing RRC Release is used for the gNB to select which UE to release.

For activation of a multicast session, RAN 2 #119bis-e has agreed on the following items.

When a Rel-18 session is activated, the UE in the inactive state can be notified (details need to be further studies).
As a baseline, the group paging can be used to notify the Rel-18 UE of activation of a session (e.g., further study is necessary for details of an operation of the UE or the like at a time of the UE receiving such a group notification).
A method for determining whether the UE can receive a multicast session in the RRC inactive state when the session is activated is determined through further study in consideration of the following solutions (the description can be further updated as needed and a plurality of solutions may be necessary).
1. When a multicast session is activated, when the PTM configuration used in the RRC inactive state for the session can be used by the UE and the UE already joins the session (such as a configuration provided to the UE via dedicated RRC signaling or an MCCH), the UE can receive the multicast session in the RRC inactive state, otherwise returns to the RRC connected state and receives the multicast session.
2. When a multicast session is activated, whether the UE can receive the multicast session in the RRC inactive state is indicated by group paging (detailed signaling needs to be further studied).
3. “Whether the UE can receive a multicast session in the RRC inactive state” is configured by dedicated signaling for the UE before the UE is released. Once the multicast session is activated, the UE remains in the RRC inactive state or resumes the RRC connection in response to the activation (detailed signaling needs to be further studied).

In Rel-17, activation of the multicast session is provided as notification through group paging. Since there is no need to be different from the legacy mechanism in Rel-18, RAN 2 needs to use the group paging to confirm that the UE is notified of the multicast session activation.

Proposal 4: RAN 2 needs to confirm that the group paging can be used to notify Rel-18 UE of activation of the session.

In addition to the confirmation, RAN 2 has defined three options for the operation of the UE at a time of receiving a multicast activation notification as mentioned above.

For option 1, the UE can receive the multicast session even in the inactive state when there exists a valid PTM configuration. The UE in the inactive state cannot receive a multicast session without the PTM configuration, which can be considered to be a baseline for all other UE operations. Hence, option 1 needs to be agreed upon.

Proposal 5: According to RAN 2, when operation option 1 of the UE multicast session is activated, when the PTM configuration used in the RRC inactive state for the session can be used by the UE, and the UE has already joined the session (a configuration provided to the UE through dedicated RRC signaling or an MCCH), the UE can receive the multicast session in the RRC inactive state.

For option 2, whether the UE needs to receive the multicast session in the inactive state is indicated at a time of the UE receiving the group paging.

For option 3, whether the UE needs to receive the multicast session in the inactive state is indicated in advance by the RRC reconfiguration or the RRC Release.

The mechanisms of these two options may be very similar except for a message indicating to do so to the UE. Therefore, these options can be analyzed from the view point of the motivations for multicast reception in the inactive state, that is, the network congestion and the power saving of the UE.

For the network congestion, a cell load is assumed to change from time to time. According to option 2, since the notification is transmitted in the group paging, the gNB can consider the latest load situation when determining whether the UE should remain in the inactive state. On the other hand, according to option 3, since the gNB needs to predict a future load when providing a notification to the UE, there exists a possibility where the cell load is changed when the gNB actually transmits the group paging. Therefore, there exists a risk that the number of UEs that transition to the connected state increases when congestion worsens, or the number of UEs that remain in the inactive state increases even when the congestion is resolved. Therefore, option 2 is desirable to efficiently control the RRC state of the UE.

From the viewpoint of power saving of the UE, some “power saving preference” is assumed to be introduced into the UE assistance information. Such a preference indication can be transmitted only from the connected UE. Hence, the gNB can indicate to the UE whether the UE is permitted to receive a multicast session in the “inactive state” when the UE is previously in the connected state. When such a preference indication is not introduced, since the gNB does not know whether the UE prefers power saving, the gNB can indicate this indication to the UE at any time. That is, there exists no difference between option 2 and option 3.

In light of the above analysis, option 2 is considered to be more efficient and cover the usage of option 3. Therefore, RAN 2 needs to agree on at least option 2.

Proposal 6: RAN 2 needs to agree on a UE operation option 2 stating that “when a multicast session is activated, whether the UE can receive the multicast session in the RRC inactive state is indicated to the UE through group paging (detailed signaling needs to be further studied)”.

With respect to option 2 group paging, the current specification defines the behavior of the UE upon receiving the group paging. Specifically, when the paging message includes a TMGI of interest, all UEs start the RRC resume procedure, and therefore when the selective paging is necessary for option 2, the gNB cannot include the TMGI in the paging message. When the gNB includes only the UE-ID for selective paging (i.e., legacy dedicated paging that is for paging the selected Rel-18 UE and that does not use the TMGI), the Rel-17 UE that waits for activation of multicast in the inactive state cannot be paged. This is also inefficient in terms of a signaling overhead.

Observation 3: That is, when the paging message includes the TMGI of interest, all UEs transition to the RRC connected state.

Assuming that a current paging group list is configured in the group paging message and at least the Rel-17 UE is paged, the Rel-18 UE is also paged through the TMGI of interest. Hence, in order that the selected UE does not transition to the connected state, it is considered to define “paging cancel list” (or “inactive permission list”) that is a new list of UE-IDs to cause the UE listed in this list to remain in the inactive state to receive the multicast session.

Hence, RAN 2 needs to discuss a method for enhancing group paging to page a subset of UEs.

Proposal 7: RAN 2 needs to discuss a method for enhancing group paging for paging a subset of UEs using, for example, a new UE-ID list for remaining in the inactive state for reception of a multicast session.

### 2.2.3. Case 3: QOS Enforcement

RAN 2 #119e has reached the following agreement relating to case 3.

HARQ feedback and PTP are not supported for multicast reception in the RRC inactive state.

According to the agreement, the multicast reception in the inactive state is the same as and/or similar to the MBS broadcast reception defined in Rel-17 (so-called delivery mode 2). The MBS broadcast is of the best-effort type.

On the other hand, ensuring QoS/reliability is an important task for the multicast session. The SA2 has also questioned whether there exists a difference in the quality/reliability of the multicast reception between the connected state and the inactive state, and RAN 2 #119bis-e has agreed on the following answers.

RAN 2 Q1-a When there exists a significant difference in quality and reliability of the MBS data reception between the UE in the RRC connected state and the UE in the RRC inactive state:
The quality and the reliability of the MBS data reception between the UE in the RRC connected state and the UE in the RRC inactive state may be different because the HARQ feedback and the PTP transmission are not supported, and the seamless/lossless mobility is not required for the multicast reception in the RRC inactive state.

RAN 2 #119e has proposed to introduce threshold values for reception quality such as RSRP and BLER, which are considered to be used to ensure a certain level of QOS requirement for multicast reception. The threshold values are also useful for the network to manage the QoS requirements. When the multicast reception in the inactive state does not meet the corresponding QoS requirement, the UE needs to transition to the connected state and ensure reception quality by using the HARQ feedback/retransmission and/or the PTP (or split MRB).

Observation 4: Even when the UE is in the inactive state, the multicast session needs to ensure a certain QoS requirement.

As for the threshold value for the RSRP, since the NR MBS assumes a single-cell transmission method, the UE is considered to be required to always transition to the connected state every time the UE moves to a cell edge or performs the cell reselection. This operation may not be an optimal operation depending on deployments from the viewpoint of the network congestion and the power saving of the UE.

The threshold values for BLER are considered to be simpler to ensure the QoS requirements. Therefore, these options need to be discussed to introduce transitions of the RRC states based on the reception quality.

Proposal 8: RAN 2 needs to agree that, when the reception quality becomes worse than the threshold value (such as the RSRP or the BLER), the UE in the inactive state should transition to the connected state.

### 2.4. Case 4: Update of PTM Configuration

RAN 2 agreed upon the following as a working premise.

The present disclosure has the mixed approach and starts as follows.
1. When the NW configures the UE to continue multicast reception in the inactive state, the NW provides the PTM configuration for the activated multicast session through RRC dedicated signaling to at least the serving cell (other cases need to be further studied).
2. The MCCH is used when the PTM configuration needs to be changed or when the PTM configuration needs to be indicated during transition beyond the serving cell/gNB. The change of the session status and other indications need to be further studied.
3. Assume that the UE can receive the multicast service after joining the session.
4. Whether the MCCH configuration is initially provided to the UE through dedicated signaling needs to be further studied.

That is, the UE may maintain the inactive state to acquire the updated PTM configuration. Therefore, when viewed from the UE in the inactive state, the delivery method of the new PTM configuration is similar to the delivery mode 2 of Rel-17. In this case, the existing MCCH change notification is very easy to reuse to provide the notification of the PTM configuration update. Therefore, no additional notification is required for updating the PTM configuration for the UE in the inactive state.

Proposal 9: RAN 2 should agree that the existing MCCH change notification is used for updating the PTM configuration.

### 2.5. Case 5: Service Continuity Upon RRC Resume

It is also conceivable that the UE already having received the multicast session in the inactive state (e.g. via the broadcast MRB) is paged and initiates the RRC resume procedure. After transitioning to the connected state, the UE of course wants to continue to receive the multicast session. However, in this case, the UE has the broadcast MRB and the resumed multicast MRB for the same multicast session. In Rel-17, reception of a multicast session only via a multicast MRB configured by an RRC reconfiguration is permitted. On the other hand, in Rel-18, reception of a multicast session via a broadcast MRB configured by an MCCH may be permitted. The UE should use the multicast MRB for reception after transitioning to the connected state. However, it is not clear how the UE switches these MRBs, when the UE discards the broadcast MRB, how the UE should do when the multicast MRB is an AM MRB (i.e., in lossless principle) and the like. Therefore, RAN 2 needs to discuss the operation of the UE upon RRC resume in terms of processing of the MRB and service continuity of the multicast session.

Proposal 10: RAN 2 should discuss the operation of the UE that is continuing to receive the multicast session upon RRC resume (such as processing of broadcast MRB and multicast MRB).

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system for providing a multicast/broadcast service (MBS), the communication method comprising:
suspending, by a user equipment, a multicast radio bearer (MRB) in response to reception of a radio resource control (RRC) Release message from a network;
transitioning, by the user equipment, from an RRC connected state to an RRC inactive state;
establishing, by the user equipment in the RRC inactive state, another multicast MRB;
transitioning, by the user equipment, from the RRC inactive state to the RRC connected state in response to reception of an RRC resume message from the network;
resuming, by the user equipment, the suspended multicast MRB in response to reception of the RRC resume message; and
discarding, by the user equipment, the another multicast MRB in response to transitioning to the RRC connected state.

2. The communication method according to claim 1, wherein the user equipment establishes the another multicast MRB based on a Multicast Control CHannel (MCCH) from the network.

3. A user equipment used in a mobile communication system for providing a multicast/broadcast service (MBS), the user equipment comprising:
a controller configured to:
suspend a multicast radio bearer (MRB) and transition from a radio resource control (RRC) connected state to an RRC inactive state, in response to reception of an RRC Release message from a network;
establish another multicast MRB when the user equipment is in the RRC inactive state;
transition from the RRC inactive state to the RRC connected state in response to reception of an RRC resume message from the network;
resume the suspended multicast MRB in response to the reception of the RRC resume message; and
discard the another multicast MRB in response to the transition to the RRC connected state.

4. A processor configured to cause a user equipment to execute the communication method according to claim 1.

5. A program for causing a user equipment to execute the communication method according to claim 1.

6. A mobile communication system comprising: the user equipment according to claim 3; and a network node.
